(19) United States
(12) Patent Application Publication
(10) Pub. No.: US 2024/0151218 A1
(43) Pub. Date: May 9, 2024

(54) MUFFLER FOR COMPRESSOR

(71) Applicant: Samsung Electronics Co., Ltd., Suwon-si (KR)

(72) Inventors: Yongtae KIM, Suwon-si (KR); Kio RYU, Suwon-si (KR)

(73) Assignee: Samsung Electronics Co., Ltd., Suwon-si (KR)

(21) Appl. No.: 18/236,569

(22) Filed: Aug. 22, 2023

Related U.S. Application Data
(63) Continuation of application No. PCT/KR2023/011510, filed on Aug. 4, 2023.

(30) Foreign Application Priority Data
Nov. 9, 2022 (KR) 10-2022-0148976

(51) Int. Cl. F04B 39/00; F16K 15/14; F16K 15/16

(52) U.S. Cl. CPC F04B 39/0061; F16K 15/1401; F16K 15/16; F25B 2500/12

(57) ABSTRACT

A muffler that is mountable on a compressor, the muffler including a body portion including an inlet to which a fluid is introducible; and a base portion connected to the body portion, the base portion including an exit flow path, an outlet at an end of the exit flow path, and a barrier extending from the outlet through the exit flow path so as to divide an exit hole of the outlet and the exit flow path, wherein the fluid introduced to the body portion flows through the base portion via the exit flow path and is discharged through the exit hole of the outlet.

### TECHNICAL FIELD

The disclosure relates to a muffler for a compressor.

### BACKGROUND ART

A hermetic compressor includes a drive motor that generates power inside a case and a compression module that receives the power from the drive motor and compresses a refrigerant. The hermetic compressor is divided into a reciprocating compressor (or a recipro compressor), a rotary compressor, a scroll compressor, etc., depending on how a refrigerant is compressed.

The reciprocating compressor is also referred to as a recipro compressor, which converts rotation power formed in the drive motor into linear reciprocating movement of a piston with a connecting rod and suctions the refrigerant to compress the same and then discharges the same through the linear reciprocating movement of the piston.

At a suction side of the compression module used in the reciprocating compressor, a suction muffler for reducing a valve impact sound, flow noise, pressure ripple, etc., occurring during suction of the refrigerant into the compression module is installed. The suction muffler may have a noise space formed therein to reduce noise occurring during suction of the refrigerant that may be introduced to the compression module through the suction muffler.

Between the suction muffler and the compression module may be installed a valve which is opened during suction of the refrigerant by the compression module to move the refrigerant from the suction muffler to the compression module.

When the refrigerant is moved to the compression module from the suction muffler, a delay may occur in opening of the valve and an opening amount of the valve may not be constant, due to flow of the refrigerant, rigidity of the valve, etc. To solve such a problem, a muffler for a compressor may be considered.

### DESCRIPTION OF EMBODIMENTS

### Solution to Problem

A muffler for a compressor, according to an embodiment of the disclosure, may be a muffler mounted on a compressor.

The muffler for the compressor, according to an embodiment of the disclosure, may include a body portion including an inlet to which a fluid is introduced.

The muffler for the compressor, according to an embodiment of the disclosure, may include a base portion connected to the body portion and including an outlet that is an exit hole through which the fluid is discharged.

The base portion of the muffler for the compressor, according to an embodiment of the disclosure, may include an exit flow path including, at a side thereof, the outlet through which the fluid is discharged.

The base portion of the muffler for the compressor, according to an embodiment of the disclosure, may include a barrier dividing an exit hole of the outlet and the exit flow path and extending from the to the exit flow path.

The base portion of the muffler for the compressor, according to an embodiment of the disclosure, may include a variable flow path portion in which the exit flow path is divided into a plurality of divided flow paths by the barrier, the variable flow path portion opening or closing any one or more of the plurality of divided flow paths.

According to an embodiment of the disclosure, a muffler that is mountable on a compressor is provided, the muffler including a body portion including an inlet to which a fluid is introducible; and a base portion connected to the body portion, the base portion including an exit flow path, an outlet at an end of the exit flow path, and a barrier extending from the outlet through the exit flow path so as to divide an exit hole of the outlet and the exit flow path, wherein the fluid introduced to the body portion flows through the base portion via the exit flow path and is discharged through the exit hole of the outlet.

According to an embodiment of the disclosure, the exit flow path may be divided into a plurality of divided flow paths by the barrier, and the plurality of divided flow paths may have a same cross-sectional area.

According to an embodiment of the disclosure, the exit flow path may be divided into a plurality of divided flow paths by the barrier, and the plurality of divided flow paths may have different cross-sectional areas.

According to an embodiment of the disclosure, the barrier may extend from the outlet through the exit flow path by a length of about 0.1 to about 1 time a length of the exit flow path.

According to an embodiment of the disclosure, the muffler may further include a valve assembly including a plurality of suction holes configured to communicate with the exit hole of the outlet. A number of suction holes of the plurality of suction holes in the valve assembly may be equal to a number of exit holes divided by the barrier.

According to an embodiment of the disclosure, the muffler may further include a suction valve configured to open and close the plurality of suction holes of the valve assembly according to movement of the fluid. The valve assembly is formed in a plate shape. The suction valve including a valve plate is formed in a plate shape, and a plurality of suction reeds each cut from the valve plate so as to be coupled at one end to the valve plate.

According to an embodiment of the disclosure, at least two suction reeds among the plurality of suction reeds may have different rigidities, different natural frequencies, or different shapes.

According to an embodiment of the disclosure, a muffler that is mountable on a compressor is provided, the muffler including a body portion including an inlet to which a fluid is introducible; and a base portion connected to the body portion, the base portion including an exit flow path, an outlet at an end of the exit flow path, a barrier extending from the outlet through the exit flow path so as to divide an exit hole of the outlet into a plurality of exit holes, and to divide the exit flow path into a plurality of divided flow paths, and a variable flow path portion in the exit flow path, wherein the fluid introduced to the body portion flows through the base portion via the exit flow path and is discharged through the exit hole of the outlet, and the variable flow path portion is configured to open and close at least one divided flow path of the plurality of divided flow paths.

According to an embodiment of the disclosure, the variable flow path portion may include a flap, and a stopper formed in a cylindrical shape and disposed in the exit flow path. The flap including a hinge portion coupled to the barrier so that the flap is rotatable, a side wall coupled to the hinge portion, a locking portion on an upper portion of the side wall, and including a first frame having a first opening through which the fluid is passable, and a support portion on a lower portion of the side wall, and including: a second frame having a second opening through which the fluid is passable, and a stopper formed in a cylindrical shape and disposed in the exit flow path. A side of the support portion of the flap is inserted into a portion of the stopper.

According to an embodiment of the disclosure, the flap may include a guide portion extending upward from the support portion and forming a curve toward the locking portion.

According to an embodiment of the disclosure, a hollow may be formed in the stopper.

According to an embodiment of the disclosure, the variable flow path portion may include an opening and closing unit configured to move inside the exit flow path, and an actuator configured to move the opening and closing unit.

According to an embodiment of the disclosure, the muffler may further include a motor unit configured to supply power to introduce the fluid to the body portion; a sensor unit configured to measure revolutions per minute (rpm) of the motor unit; and a controller configured to control an operation of the actuator based on the rpm measured by the sensor unit.

According to an embodiment of the disclosure, the muffler may further include a valve assembly including a plurality of suction holes configured to communicate with the exit hole of the outlet. A number of suction holes of the plurality of suction holes in the valve assembly may be equal to a number of exit holes divided by the barrier.

According to an embodiment of the disclosure, the muffler may further include a suction valve configured to open and close the plurality of suction holes of the valve assembly according to movement of the fluid. The valve assembly is formed in a plate shape. The suction valve including a valve plate is formed in a plate shape, and a plurality of suction reeds each cut from the valve plate so as to be coupled at one end to the valve plate. At least two suction reeds among of the plurality of suction reeds may have different rigidities, different natural frequencies, or different shapes.

### BRIEF DESCRIPTION OF DRAWINGS

FIG. 1 is an exploded perspective view of a compressor according to an embodiment of the disclosure.

FIG. 2 is a view showing an operating method of a compression module of a compressor, according to an embodiment of the disclosure.

FIG. 3 is a schematic perspective view of a base portion according to an embodiment of the disclosure.

FIG. 4 is an internal cross-sectional view of a base portion according to an embodiment of the disclosure.

FIG. 5 is a schematic perspective view of a valve assembly according to an embodiment of the disclosure.

FIG. 6 is a schematic perspective view of a suction valve according to an embodiment of the disclosure.

FIG. 7 schematically shows an internal cross-section of a base portion and a suction hole of a valve assembly, according to an embodiment of the disclosure.

FIG. 8 shows an opening amount of a suction reed when a fluid moves through two suction reeds having the same rigidity, the same natural frequency, and the same shape in which an outlet includes one hole without being divided by a barrier.

FIG. 9 shows two suction reeds having different rigidities, natural frequencies, and shapes in a suction valve, according to an embodiment of the disclosure.

FIG. 10 shows an opening amount of a suction reed when a fluid moves through two suction reeds having different rigidities, different natural frequencies, and different shapes in a suction valve.

FIG. 11 shows an opening amount of a suction reed when a fluid moves through two suction reeds having different rigidities, different natural frequencies, and different shapes in which an outlet includes one hole without being divided by a barrier.

FIG. 12 shows an opening amount of a suction reed when a fluid moves through a first suction reed and a second suction reed having different rigidities and different natural frequencies in a suction valve.

FIG. 13 schematically shows movement of a fluid through a second divided flow path in a low rpm section in a variable flow path portion including a stopper and a flap, according to an embodiment of the disclosure.

FIG. 14 schematically shows movement of a fluid through a first divided flow path in a high rpm section in a variable flow path portion including a stopper and a flap, according to an embodiment of the disclosure.

FIG. 15 schematically shows a hollow formed in a stopper, according to an embodiment of the disclosure.

FIG. 16 schematically shows a variable flow path portion including an opening and closing unit and an actuator, according to an embodiment of the disclosure.

### MODE OF DISCLOSURE

Throughout the disclosure, the expression “at least one of a, b or c” indicates only a, only b, only c, both a and b, both a and c, both b and c, all of a, b, and c, or variations thereof.

Hereinafter, an example embodiment of the disclosure will be described in detail with reference to matters described in the accompanying drawings. The same reference numeral or symbol presented in each drawing represents a part or component that performs substantially the same function.

The terms including “first”, “second”, etc., may be used to explain various components, but the components are not limited by the terms. These terms may be used to distinguish one element from another element. For example, a first component may be referred to as a second component without departing from the scope of the disclosure, and similarly, the second component may be referred to as the first component. The term “and/or” may include a combination of a plurality of related items or any one of the plurality of related items.

The term used herein is used to describe an embodiment of the disclosure, and is not intended to limit and/or restrict the disclosure. Singular forms include plural forms unless apparently indicated otherwise contextually. Moreover, it should be understood that the term “include”, “have”, or the like used herein is to indicate the presence of features, numbers, steps, operations, elements, parts, or a combination thereof described in the specifications, and does not preclude the presence or addition of one or more other features, numbers, steps, operations, elements, parts, or a combination thereof. The same reference numeral presented in each drawing represents a member that substantially performs the same function.

A fluid used in a compressor according to an embodiment of the disclosure may be a refrigerant. However, the disclosure is not limited thereto, and the fluid used in the compressor according to an embodiment of the disclosure may be a fluid other than a refrigerant. A compressor according to an embodiment of the disclosure may be a reciprocating compressor (or a recipro compressor). However, the disclosure is not limited thereto, and the compressor according to an embodiment of the disclosure may be another type of compressor.

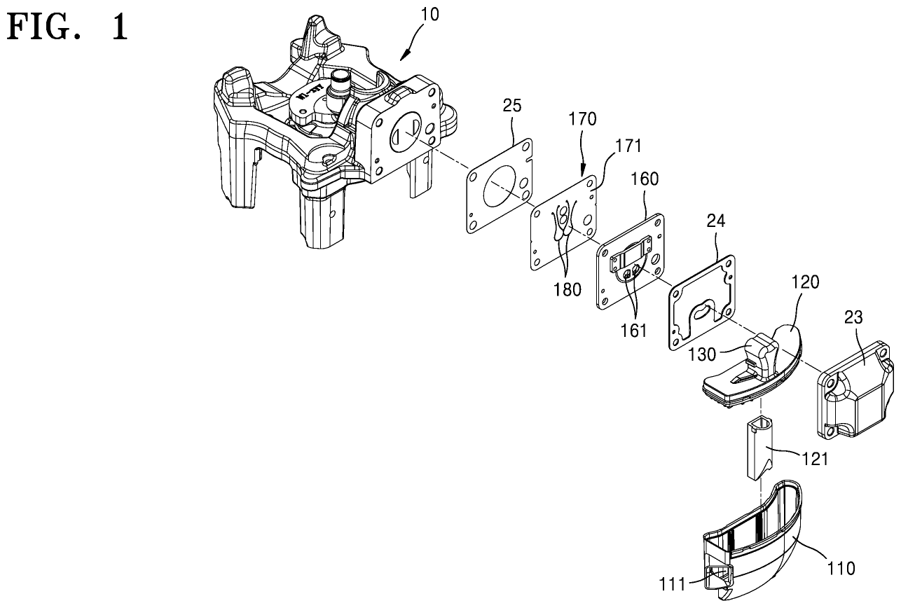

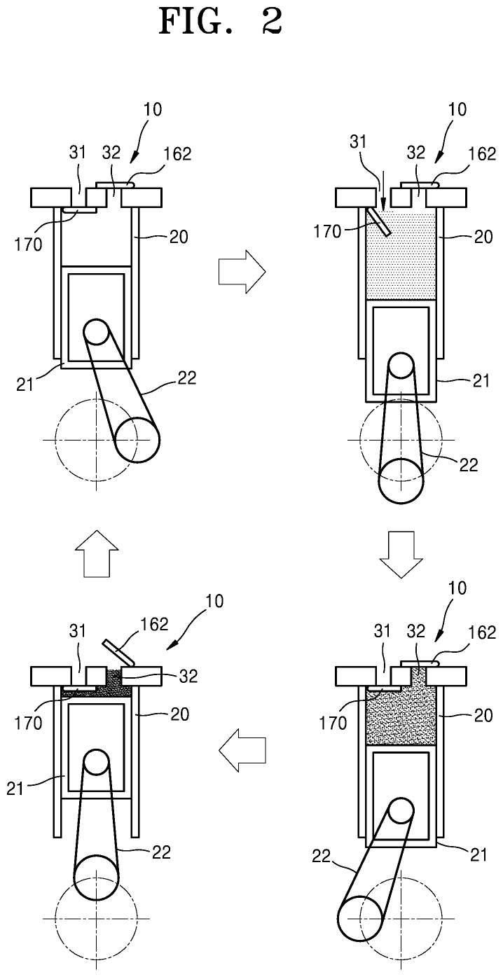

FIG. 1 is an exploded perspective view of a compressor according to an embodiment of the disclosure, and FIG. 2 is a view showing an operating method of a compression module 10 of a compressor according to an embodiment of the disclosure.

A compressor according to an embodiment of the disclosure may be a reciprocating compressor, and the compressor according to the embodiment may include the compression module 10 that compresses a fluid. The compression module 10 may include a cylinder 20, a piston 21, a rod 22, a suction portion 31, a discharge portion 32, a suction valve 170, and a discharge valve 162.

Referring to FIG. 2, the compression module 10 according an embodiment may convert rotation power generated in a drive motor into linear reciprocation through the rod 22. The linear reciprocation of the rod 22 may cause the piston 21 to linearly reciprocate inside the cylinder 20 while suctioning the fluid into the cylinder 20, compressing the fluid, and then discharging the same.

More specifically, when the piston 21 retreats inside the cylinder 20 by the rod 22, an inner side of the cylinder 20 may expand, causing the fluid to flow into the cylinder 20 through the suction portion 31. At this time, the suction valve 170 provided in the suction portion 31 may be opened by suction power of the fluid, causing the fluid to flow into the cylinder 20.

When the piston 21 is advanced into the cylinder 20 by the rod 22, the fluid inside the cylinder 20 may be compressed. The fluid compressed inside the cylinder 20 may be discharged to an outside through the discharge portion 32. At this time, as the discharge valve 162 provided in the discharge portion 32 may be opened by a discharge pressure of the fluid, the fluid may be discharged to the outside of the cylinder 20.

In this process, the compression module 10 of the compressor may suction, compress, and then discharge the fluid. The fluid suctioned by the suction portion 31 of the compression module 10 may be supplied through a suction muffler. A muffler for a compressor according to an embodiment of the disclosure may relate to a suction muffler, and may supply fluid suctioned to the compression module 10.

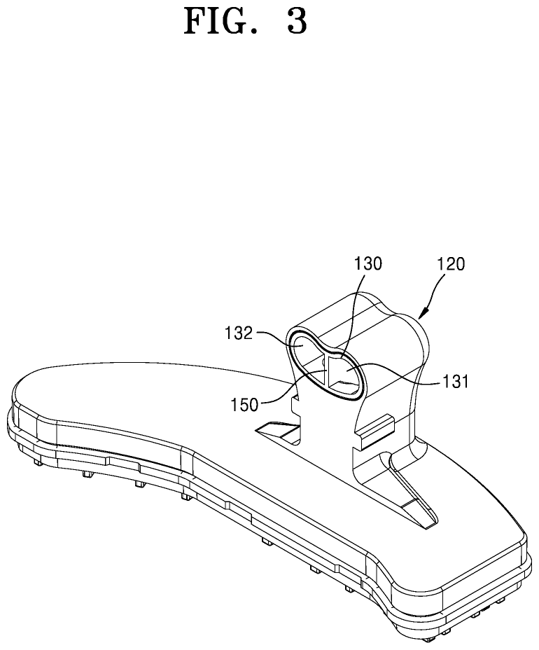

FIG. 3 is a schematic perspective view of a base portion 120 according to an embodiment of the disclosure. Referring to FIGS. 1 and 3, a muffler for a compressor according to an embodiment of the disclosure may include a body portion 110 and the base portion 120.

Referring to FIG. 1, the body portion 110 according to an embodiment of the disclosure may include an inlet 111 through which a fluid is introduced. The fluid may be supplied into the body portion 110 through the inlet 111 of the body portion 110, and the fluid supplied to the body portion 110 may be supplied to the base portion 120.

The body portion 110 may reduce a valve impact sound, a flow noise, a pressure ripple, etc., generated in suction of the fluid, and a noise space may be formed in the body portion 110 according to an embodiment.

The base portion 120 according to an embodiment of the disclosure may be connected to the body portion 110 and may be provided with an outlet 130 that is an exit hole through which the fluid is discharged. The fluid supplied to the body portion 110 may move to the base portion 120, and the fluid moving to the base portion 120 may be discharged to the outside through the outlet 130. The fluid discharged through the outlet 130 may be supplied to the compression module 10.

The muffler for a compressor according to an embodiment of the disclosure may further include a duct 121. The duct 121 may connect the body portion 110 to the base portion 120, and the fluid supplied to the body portion 110 may be moved to the base portion 120 through the duct 121. The duct 121 according to an embodiment of the disclosure may have various shapes as long as the duct 121 may connect the body portion 110 to the base portion 120.

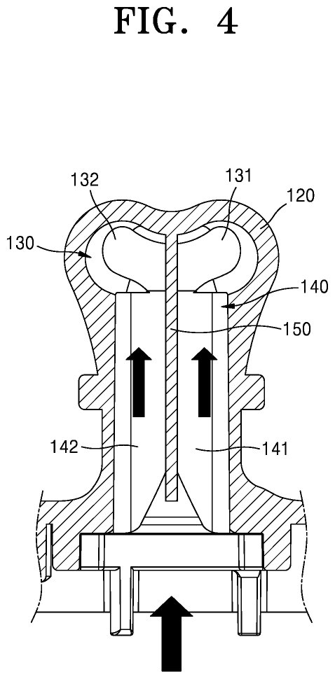

FIG. 4 is an internal cross-sectional view of the base portion 120 according to an embodiment of the disclosure. Referring to FIG. 4, the base portion 120 according to an embodiment of the disclosure may include an exit flow path 140 and a barrier 150.

The exit flow path 140 according to an embodiment of the disclosure may include the outlet 130 at a side thereof through which the fluid is discharged, and the exit flow path 140 may be a passage through which the fluid may move. The exit flow path 140 may be in communication with the outlet 130, and the fluid introduced to the body portion 110 may be discharged to the outlet 130 through the exit flow path 140.

The barrier 150 according to an embodiment of the disclosure may divide an exit hole of the outlet 130 and the exit flow path 140 and extend from the outlet 130 to the exit flow path 140. The barrier 150 may be provided inside the base portion 120, the exit flow path 140 may be divided into a plurality of divided flow paths through the barrier 150, and the outlet 130 may be divided into a plurality of exit holes.

According to an embodiment of the disclosure, one barrier 150 may be provided inside the base portion 120. As one barrier 150 is provided in the base portion 120, the outlet 130 may be divided into a first exit hole 131 and a second exit hole 132. As one barrier 150 is provided in the base portion 120, the exit flow path 140 may be divided into a first divided flow path 141 and a second divided flow path 142. In this way, as one barrier 150 is provided inside the base portion 120, the outlet 130 and the exit flow path 140 may be divided into two exit holes and divided flow paths.

However, the number of barriers 150 provided inside the base portion 120 is not limited to one, and a plurality of barriers 150 may be provided inside the base portion 120. When two barriers 150 are provided inside the base portion 120, the outlet 130 and the exit flow path 140 may be divided into three exit holes and divided flow paths, and when three barriers 150 are provided inside the base portion 120, the outlet 130 and the exit flow path 140 may be divided into four exit holes and divided flow paths.

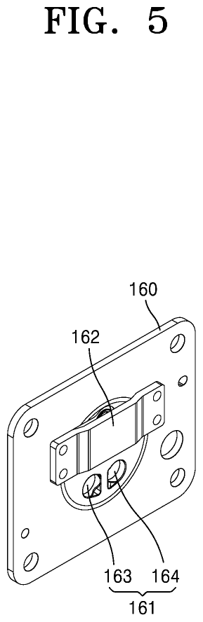

The muffler for a compressor according to an embodiment of the disclosure may further include a valve assembly 160 provided with a suction hole 161. FIG. 5 is a schematic perspective view of the valve assembly 160 according to an embodiment of the disclosure.

Referring to FIGS. 1 and 5, the valve assembly 160 may include a plurality of suction holes 161 communicating with the exit hole of the outlet 130. The valve assembly 160 may have a plate shape, and may be disposed in front of the base portion 120.

When the valve assembly 160 is disposed in front of the base portion 120, the valve assembly 160 may be disposed in front of the base portion 120 such that the suction hole 161 of the valve assembly 160 communicates with the exit hole of the outlet 130.

A discharge hole may also be provided in the valve assembly 160 according to an embodiment of the disclosure, and a discharge valve 162 capable of opening and closing the discharge hole may be provided in the valve assembly 160.

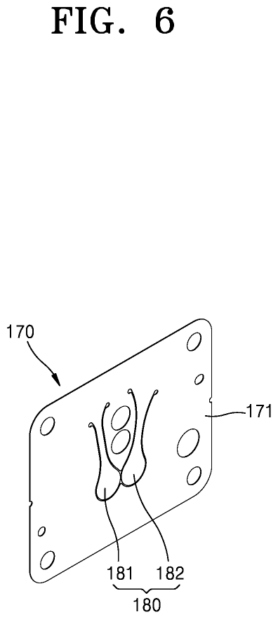

The muffler for a compressor according to an embodiment of the disclosure may further include a suction valve 170 that opens and closes the suction hole 161 of the valve assembly 160 according to movement of the fluid. FIG. 6 is a schematic perspective view of the suction valve 170 according to an embodiment of the disclosure.

Referring to FIGS. 1 and 6, the suction valve 170 may open the suction hole 161 when the compression module 10 suctions the fluid, and close the suction hole 161 when the compression module 10 discharges the fluid.

The suction valve 170 according to an embodiment of the disclosure may include a valve plate 171 and a suction reed 180. The valve plate 171 may have a plate shape and may be disposed in front of the valve assembly 160.

A suction reed 180 may be provided on the valve plate 171, and one end of the suction reed 180 may be coupled to the valve plate 171 and may be formed by cutting the valve plate 171 into a certain shape.

More specifically, the suction reed 180 may be formed by cutting the valve plate 171 into the certain shape, and in this case, an end of a side of the suction reed 180 may not be cut so as not to be separated from the valve plate 171.

The suction reed 180 may move along the movement of the fluid, and upon movement of the fluid in the suction valve 170, the suction reed 180 may move along the movement of the fluid with respect to the end of the side thereof.

The suction valve 170 may be disposed in front of the valve assembly 160. When the suction valve 170 is disposed in front of the valve assembly 160, the suction reed 180 of the suction valve 170 may be disposed in front of the suction hole 161 of the valve assembly 160.

When the suction reed 180 moves along the movement of the fluid, the suction reed 180 may move in a direction to contact or to be away from the suction hole 161 of the valve assembly 160. When the suction reed 180 moves in a direction to contact the suction hole 161 of the valve assembly 160, the suction hole 161 may be closed, and when the suction reed 180 moves in a direction to be away from the suction hole 161 of the valve assembly 160, the suction hole 161 may be opened.

The number of suction holes 161 provided in the valve assembly 160 according to an embodiment of the disclosure may be equal to the number of exit holes divided by the barrier 150. In addition, the number of suction reeds 180 provided in the suction valve 170 according to an embodiment of the disclosure may be equal to the number of suction holes 161 provided in the valve assembly 160 or the number of exit holes divided by the barrier 150.

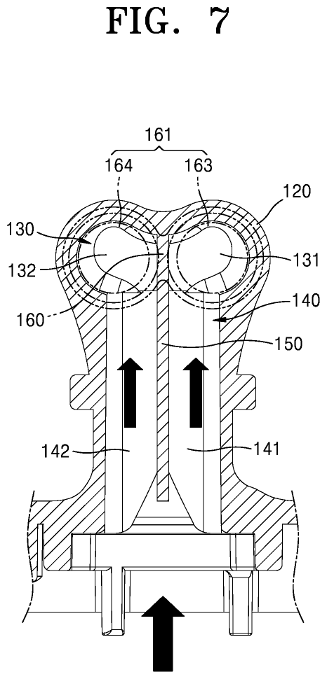

FIG. 7 schematically shows an internal cross-section of the base portion 120 and the suction hole 161 of the valve assembly 160, according to an embodiment of the disclosure.

Referring to FIG. 7, the number of exit holes divided by the barrier 150 may be equal to the number of suction holes 161 and the number of suction reeds 180, in which one exit hole may communicate with one suction hole 161 and one suction reed 180.

According to an embodiment of the disclosure, the outlet 130 may be divided into a first exit hole 131 and a second exit hole by one barrier 150. When the outlet 130 is divided into the first exit hole 131 and the second exit hole 132, the valve assembly 160 may include two suction holes 161 including a first suction hole 163 and a second suction hole 164.

When the outlet 130 is divided into the first exit hole 131 and the second exit hole 132 and the valve assembly 160 includes the first suction hole 163 and the second suction hole 164, the suction valve 170 may include two suction reeds 180 including a first suction reed 181 and a second suction reed 182.

Referring to FIG. 1, upon generation of suction power in the compression module 10 by the rod 22 and the piston 21 of the compression module 10, the fluid supplied to the body portion 110 may move to the compression module 10 through the outlet 130 of the base portion 120. The fluid passing through the outlet 130 of the base portion 120 may pass through the suction hole 161 of the valve assembly 160 and the suction reed 180 of the suction valve 170.

As the suction power is generated in the compression module 10, the suction reed 180 may move in a direction away from the suction hole 161 and thus cause the suction hole 161 to be opened.

Referring to FIG. 1, the valve assembly 160 may be disposed in front of the base portion 120 according to an embodiment of the disclosure, and the suction valve 170 may be disposed in front of the valve assembly 160. The compression module 10 may be disposed in front of the suction valve 170.

A gasket 24 for sealing may be provided between the valve assembly 160 according to an embodiment of the disclosure and the base portion 120, and a gasket valve 25 having a hole formed therein may be disposed between the suction valve 170 and the compression module 10, in which the suctioned fluid and the discharged fluid may pass through the hole. At the rear of the base portion 120, a cylinder head 23 may be disposed to cover the base portion 120, the gasket 24, the valve assembly 160, the suction valve 170, and the gasket valve 25.

According to an embodiment of the disclosure, the plurality of suction reeds 180 provided in the suction valve 170 may have the same rigidity and the same natural frequency, and may be formed in the same shape. FIG. 6 shows the suction valve 170 including two suction reeds 180 (the first suction reed 181 and the second suction reed 182) having the same rigidity, the same natural frequency, and the same shape.

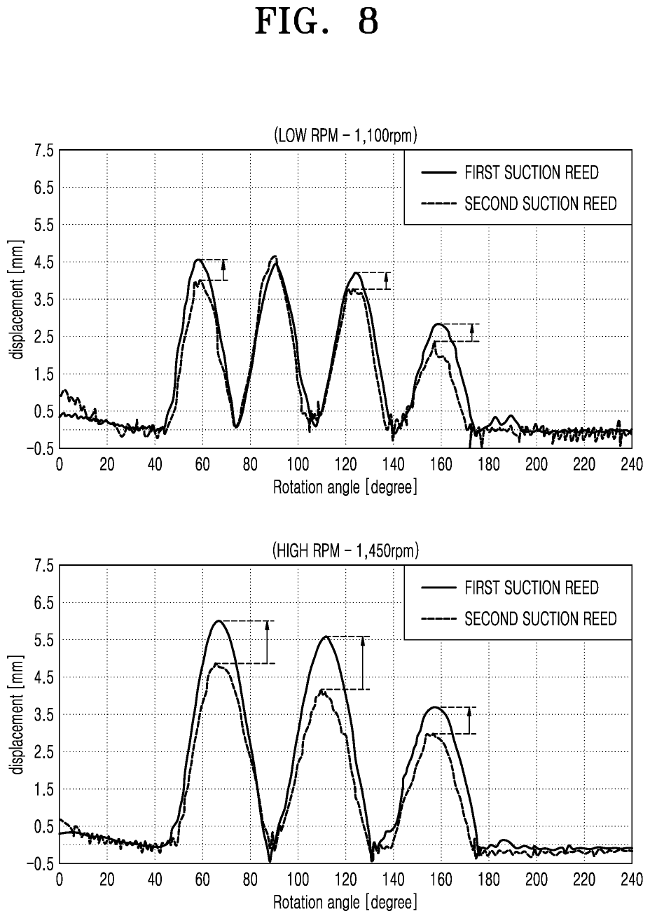

FIG. 8 shows an opening amount of a suction reed with respect to a rotation angle of the rod 22 when a fluid moves through two suction reeds having the same rigidity, the same natural frequency, and the same shape in which the exit hole of the outlet 130 includes one hole without being divided by a barrier. In FIG. 8, the valve assembly 160 may include two suction holes 161, and the suction valve 170 may include two suction reeds 180.

The fluid introduced to the body portion 110 according to an embodiment of the disclosure may be introduced to the body portion 110 by power of a motor, and the fluid may be supplied at a high pressure for high revolutions per minute (rpm) of the motor.

When the suction reed 180 opens the suction hole 161 by movement of the fluid with generation of suction power in the compression module 10, vibration may occur due to the natural frequency of the suction reed 180 and thus the suction reed 180 may repeatedly open and close the suction hole 161.

Referring to FIG. 8, when the exit hole of the outlet 130 includes one hole without being divided by the barrier, a difference may occur in an opening amount between the two suction reeds 180.

More specifically, two suction reeds 180 may have the same rigidity, the same natural frequency, and the same shape, but the fluid discharged through one exit hole does not uniformly move to the two suction holes 161, resulting in a difference in an opening amount between the two suction reeds 180.

Referring to FIG. 8, as the rpm of the motor that provides power for supplying fluid to the body portion 110 increases, a difference in an opening amount between the two suction reeds 180 may increase.

However, in the muffler for a compressor according to an embodiment of the disclosure, the exit hole of the outlet 130 may be divided through the barrier 150 and each of the plurality of suction holes communicate with the divided exit hole, thereby dividing a passage of the fluid moving to the plurality of suction reeds 180. In this way, the muffler for a compressor according to an embodiment of the disclosure may reduce a difference in an opening amount between the two suction reeds 180.

According to an embodiment of the disclosure, at least one of the plurality of suction reeds 180 provided in the suction valve 170 may have different rigidities, different natural frequencies, or different shapes. When the suction valve 170 includes the plurality of suction reeds 180, at least one of the plurality of suction reeds 180 may have a rigidity, a natural frequency, or a shape that is different from those of the other suction reeds 180.

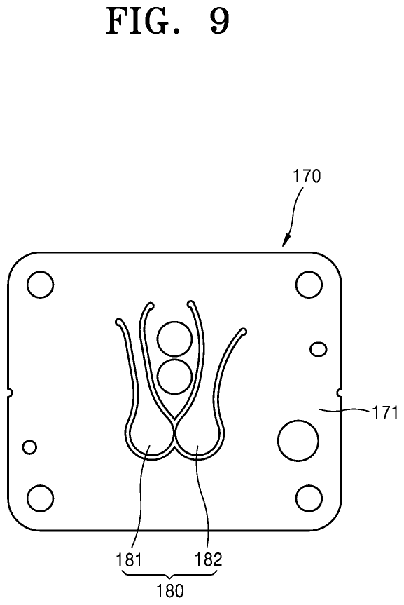

FIG. 9 shows the suction valve 170 including two suction reeds 180 (the first suction reed 181 and the second suction reed 182) having different rigidities, different natural frequencies, and different shapes, according to an embodiment of the disclosure.

Referring to FIG. 8, when the suction valve 170 includes two suction reeds 180 having the same rigidity, the same natural frequency, and the same shape, a difference in an opening amount may occur between the two suction reeds 180, but the two suction reeds 180 may be opened and closed at the same time.

When the two suction reeds 180 are opened and closed at the same time, a fluid may not be suctioned in a section where the two suction reeds 180 are closed at the same time, failing to continuously supply the fluid to the compression module 10.

To prevent this phenomenon, at least one of the plurality of suction reeds 180 provided in the suction valve 170 according to an embodiment of the disclosure may have different rigidities, different natural frequencies, or different shapes.

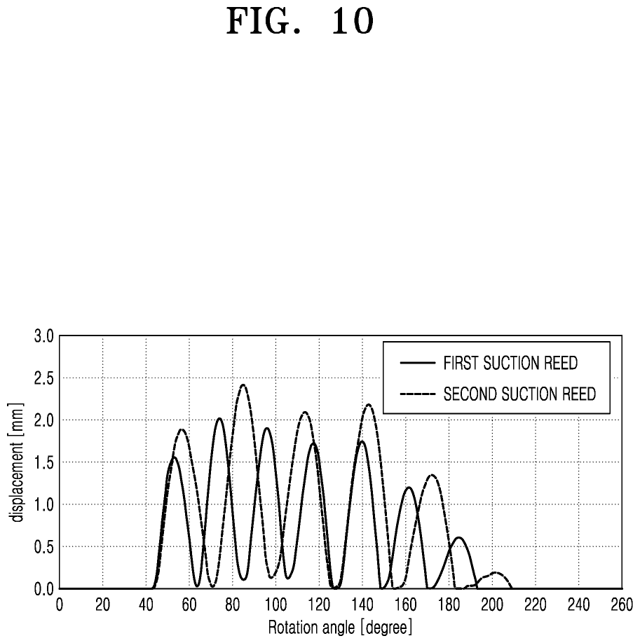

FIG. 10 shows an opening amount of a suction reed with respect to a rotation angle of the rod 22 when a fluid moves through the two suction reeds 180 having different rigidities, different natural frequencies, and different shapes in the suction valve 170.

Referring to FIG. 10, when the two suction reeds 180 have different rigidities, the suction reed 180 with a low rigidity may open first and thus have a large opening amount, and the suction reed 180 with a high rigidity may open later and thus have a small opening amount. As the two suction reeds 180 are not opened and closed at the same time, the section where the two suction reeds 180 are closed at the same time may be removed, thereby continuously supplying the fluid to the compression module 10.

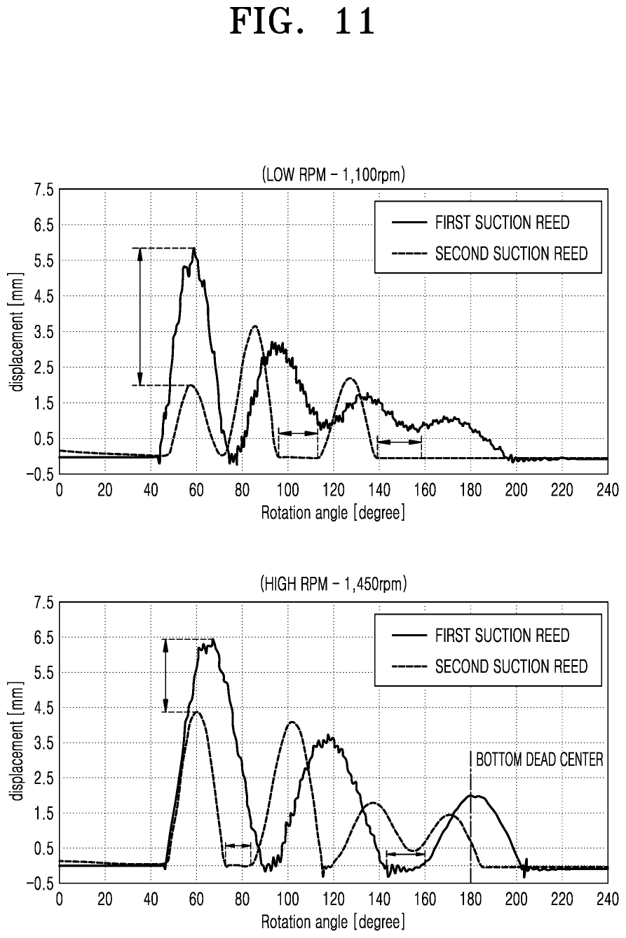

FIG. 11 shows an opening amount of a suction reed with respect to a rotation angle of the rod 22 when a fluid moves through the two suction reeds 180 having different rigidities, different natural frequencies, and different shapes in which the outlet 130 includes one hole without being divided by a barrier.

Referring to FIG. 11, when the exit hole of the outlet 130 includes one hole without being divided by the barrier, a long opening delay or a large opening amount difference may occur between the two suction reeds 180. In addition, the suction reed 180 may be opened even after a bottom dead center that is a time point at which the fluid is discharged after suctioned in the compression module 10.

More specifically, to remove a section where the two suction reeds 180 are closed at the same time by using the two suction reeds 180 having different rigidities, a fluid discharged through one exit hole may not uniformly move to the two suction holes 161, resulting in a long opening delay or a large opening amount difference between the two suction reeds 180.

Upon occurrence of the opening delay, a section where the two suction reeds 180 are not opened at the same time may be generated, resulting in reduction of a suction amount of the fluid suctioned to the compression module 10.

Moreover, as an rpm of a motor that supplies power for supplying the fluid to the body portion 110 increases, the fluid discharged through one exit hole may not uniformly move to the two suction holes 161, resulting in a long opening delay or a large opening amount difference and a phenomenon where the suction reed 180 are opened even after the bottom dead center.

However, in the muffler for a compressor according to an embodiment of the disclosure, the exit hole of the outlet 130 may be divided through the barrier 150 and each of the plurality of suction holes communicate with the divided exit hole, thereby dividing a passage of the fluid moving to the plurality of suction reeds 180.

In this way, the muffler for a compressor according to an embodiment of the disclosure may prevent a long opening delay or a large opening amount difference as the two suction reeds 180 independently operate, and may also prevent the suction reed 180 from being opened even after the bottom dead center.

The exit flow path 140 according to an embodiment of the disclosure may be divided into a plurality of divided flow paths by the barrier 150, and the plurality of divided flow paths may have the same cross-sectional area.

According to an embodiment of the disclosure, the exit flow path 140 may be divided into a first divided flow path 141 and a second divided flow path 142 by one barrier 150. In this case, the first divided flow path 141 and the second divided flow path 142 may have the same cross-sectional area.

The exit flow path 140 according to an embodiment of the disclosure may be divided into a plurality of divided flow paths by the barrier 150, and the plurality of divided flow paths may have different cross-sectional areas.

According to an embodiment of the disclosure, the exit flow path 140 may be divided into a first divided flow path 141 and a second divided flow path 142 by one barrier 150. In this case, the first divided flow path 141 and the second divided flow path 142 may have different cross-sectional areas.

When at least one of the plurality of suction reeds 180 provided in the suction valve 170 has a rigidity, a natural frequency, or a shape that is different from those of the other suction reeds 180, the amount of movement of the fluid may need to vary with the rigidity, the natural frequency, and the shape of the suction reed 180. To this end, the exit flow path 140 may be divided into a plurality of divided flow paths by the barrier 150, and the plurality of divided flow paths may have different cross-sectional areas.

According to an embodiment of the disclosure, a cross-sectional area of a divided flow path having the largest cross-sectional area among the plurality of divided flow paths by the barrier 150 may be about 1 to about 1.1 times a cross-sectional area of a divided flow path having the smallest cross-sectional area among the plurality of divided flow paths.

When the exit flow path 140 is divided into the plurality of divided flow paths by the barrier 150 and the plurality of divided flow paths have different cross-sectional areas, the cross-sectional areas of the plurality of divided flow paths may change with the rigidity, the natural frequency, and the shape of the suction reed 180, and a difference between the divided flow path having the largest cross-sectional area and the divided flow path having the smallest cross-sectional area among the plurality of divided flow paths may be less than about 10%.

The barrier 150 extending from the outlet 130 to the exit flow path 140 according to an embodiment of the disclosure may extend by a length that is about 0.1 time to 1 time the length of the exit flow path 140. The barrier 150 extending from the outlet 130 to the exit flow path 140 may divide the entire exit flow path 140.

The barrier 150 extending from the outlet 130 to the exit flow path 140 may divide a part of the exit flow path 140. However, in this case, the exit hole of the outlet 130 may be divided by the barrier 150 that may extend toward the exit flow path 140 to the extent that fluids discharged through the exit holes of the outlet 130 do not affect each other when the fluids are respectively discharged from the exit holes of the outlet 130.

The base portion 120 of the muffler for a compressor according to an embodiment of the disclosure may further include a variable flow path portion 200. The variable flow path portion 200 according to an embodiment of the disclosure may open or close any one or more of the plurality of divided flow paths.

The variable flow path portion 200 according to an embodiment of the disclosure may be provided inside the exit flow path 140. The variable flow path portion 200 may open any one of the divided flow paths divided by the barrier 150 and close the other divided flow path.

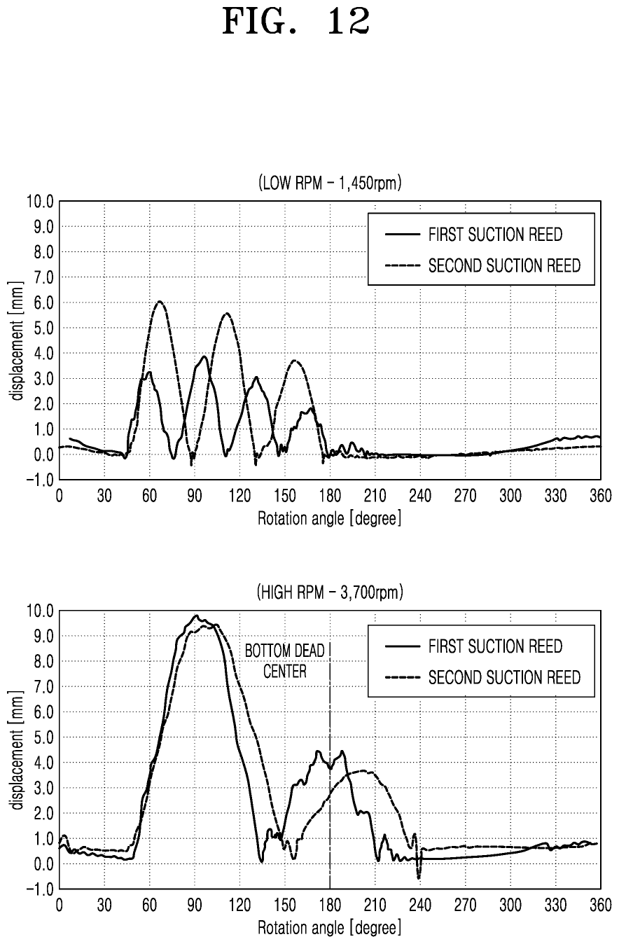

FIG. 12 shows an opening amount of a suction reed with respect to an angle of rotation of the rod 22 when a suction valve includes the first suction reed 181 and the second suction reed 182 having different rigidities and natural frequencies and a fluid moves through the first suction reed 181 and the second suction reed 182. In FIG. 12, the first suction reed 181 may have a higher rigidity and a higher natural frequency than those of the second suction reed 182.

The fluid introduced to the body portion 110 according to an embodiment of the disclosure may be introduced to the body portion 110 by power of a motor, and the fluid may be supplied at a high pressure for a high rpm of the motor.

Referring to FIG. 12, when the fluid moves through the first suction reed 181 and the second suction reed 182 having different rigidities and natural frequencies, the opening amount of the first suction reed 181 having a high rigidity and a high natural frequency may be less than that of the second suction reed 182 in a low rpm section. As the opening amount of the first suction reed 181 having a high rigidity and a high natural frequency is small in the low rpm section, the fluid may not efficiently move.

When the fluid moves through the first suction reed 181 and the second suction reed 182 having different rigidities and different natural frequencies, an opening and closing delay may occur in the second suction reed 182 having a low rigidity and a low natural frequency in a high rpm section.

After the bottom dead center that is a time point at which the fluid is discharged after suctioned in the compression module 10, the suction reed needs to be closed, but the second suction reed 182 may be opened after the bottom dead center in the high rpm section as the opening and closing delay occurs in the second suction reed 182 having a low rigidity and a low natural frequency.

To solve such a problem, the muffler for a compressor according to an embodiment of the disclosure may use the variable flow path portion 200. The variable flow path portion 200 may open or close any one or more of the plurality of divided flow paths.

According to an embodiment of the disclosure, with the variable flow path portion 200, the fluid may move through the divided flow path connected to the suction reed (the second suction reed 182) having a low rigidity and a low natural frequency in the low rpm section, and the fluid may move through the divided flow path connected to the suction reed (the first suction reed 181) having a high rigidity and a high natural frequency in the high rpm section.

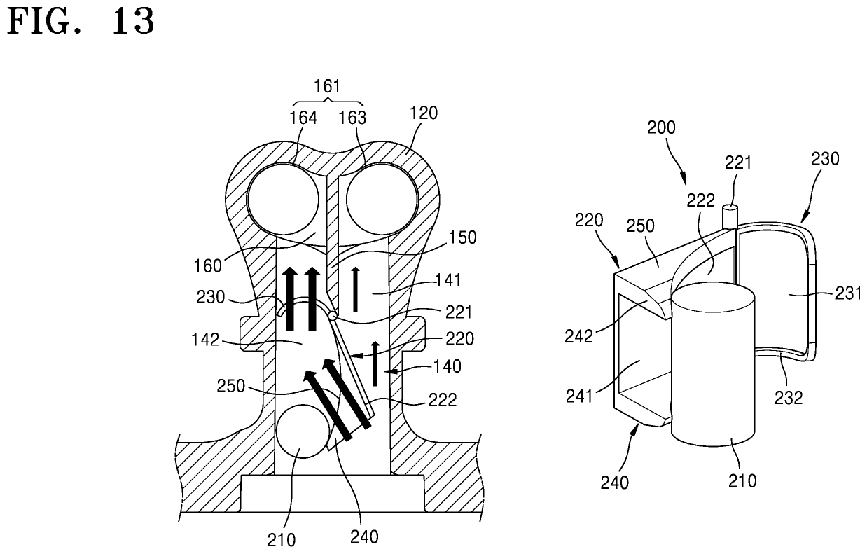

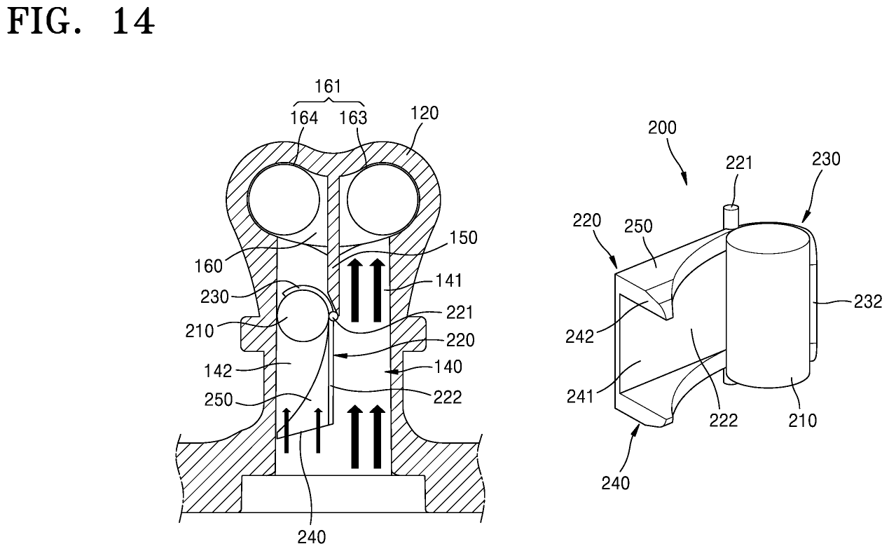

The variable flow path portion 200 according to an embodiment of the disclosure may include a stopper 210 and a flap 220. FIG. 13 schematically shows movement of a fluid through the second divided flow path 142 in the low rpm section in the variable flow path portion 200 including a stopper and a flap, according to an embodiment of the disclosure. FIG. 14 schematically shows movement of a fluid through the first divided flow path 141 in the high rpm section in the variable flow path portion 200 including the stopper and the flap, according to an embodiment of the disclosure.

Referring to FIGS. 13 and 14, the stopper 210 may be disposed in the exit flow path 140, and may have a cylindrical shape. The flap 220 according to an embodiment of the disclosure may include a hinge portion 221, a side wall 222, a locking portion 230, and a support portion 240.

The hinge portion 221 according to an embodiment of the disclosure may include a hinge as a portion coupled to the barrier 150. The hinge portion 221 may be rotatably coupled to the barrier 150, and the flap 220 may rotate through the hinge portion 221 inside the exit flow path 140.

The side wall 222 according to an embodiment of the disclosure may be coupled to the hinge portion 221, and may have a plate shape that divides the exit flow path 140. The side wall 222 may be rotated by the hinge portion 221.

The locking portion 230 according to an embodiment of the disclosure may be provided on an upper portion of the side wall 222 and may include a first opening 231 and a first frame 232 through which the fluid may pass. The locking portion 230 may be provided on the upper portion of the side wall 222, and the first frame 232 of the locking portion 230 may extend from the upper portion of the side wall 222 to protrude outwardly. The first opening 231 may be a hole formed inside the first frame 232, and the fluid may pass through the first opening 231.

The support portion 240 according to an embodiment of the disclosure may be provided on a lower portion of the side wall 222 and may include a second opening 241 and a second frame 242 through which the fluid may pass. The support portion 240 may be provided on the lower portion of the side wall 222, and the second frame 242 of the support portion 240 may extend from the lower portion of the side wall 222 to protrude outwardly. The second opening 241 may be a hole formed inside the second frame 242, and the fluid may pass through the second opening 241.

According to an embodiment of the disclosure, the locking portion 230 and the support portion 240 extending from the upper portion and the lower portion of the side wall 222 to protrude outwardly may extend to protrude from the upper portion and the lower portion of the side wall 222 toward the stopper 210.

According to an embodiment of the disclosure, a side of the support portion 240 of the flap 220 may be inserted into a lower portion of the stopper 210. Referring to FIG. 13, the stopper 210 may be disposed at a side of a lower portion of the exit flow path 140, and a side of the support portion 240 of the flap 220 may be inserted into the lower portion of the stopper 210.

When the side of the support portion 240 of the flap 220 is inserted into the portion of the stopper 210, the flap 220 may be inclined toward an inner side of the exit flow path 140 as shown in FIG. 13, thus blocking one of the plurality of divided flow paths through the side wall 222 of the flap 220. In this case, the flap 220 may completely or partially block one of the plurality of divided flow paths.

The stopper 210 may move according to a pressure of the fluid. The stopper 210 may move to an upper portion of the exit flow path 140 when the pressure of the fluid higher than a weight of the stopper 210 is generated, and the stopper 210 may not move when the pressure of the fluid lower than the weight of the stopper 210 is generated.

When the stopper 210 according to an embodiment of the disclosure is moved by the pressure of the fluid, the stopper 210 may move between the support portion 240 of the flap 220 and the locking portion 230 of the flap 220. The first opening 231 provided in the locking portion 230 according to an embodiment of the disclosure may be a hole with a size less than that of the stopper 210, and when the stopper 210 moves to the locking portion 230, the stopper 210 may contact the first frame 232 while blocking the first opening 231 of the locking portion 230.

The flap 220 according to an embodiment of the disclosure may further include a guide portion 250 extending while forming an upward curve in a direction from the support portion 240 to the locking portion 230. The guide portion 250 may extend in a round curve from the support portion 240 toward the locking portion 230. When the stopper 210 is moved by the pressure of the fluid, the stopper 210 may move from the support portion 240 to the locking portion 230 along a curve of the guide portion 250.

The variable flow path portion 200 according to an embodiment of the disclosure may open a divided flow path connected to a suction reed having a low rigidity and a low natural frequency and close a divided flow path connected to a suction reed having a high rigidity and a high natural frequency, in the low rpm section.

The variable flow path portion 200 according to an embodiment of the disclosure may open a divided flow path connected to a suction reed having a high rigidity and a high natural frequency and close a divided flow path connected to a suction reed having a low rigidity and a low natural frequency, in the high rpm section.

Referring to FIGS. 13 and 14, the exit flow path 140 may be divided into the first divided flow path 141 and the second divided flow path 142 by the barrier 150. The first divided flow path 141 may communicate with the first suction hole 163 that may be opened and closed by the first suction reed 181. The second divided flow path 142 may communicate with the second suction hole 164 that may be opened and closed by the second suction reed 182. The first suction reed 181 may have a high rigidity and a high natural frequency than those of the second suction reed 182.

The stopper 210 according to an embodiment of the disclosure may be disposed in a lower portion of the second divided flow path 142, and a side of the support portion 240 of the flap 220 may be inserted into the lower portion of the stopper 210. When the side of the support portion 240 of the flap 220 is inserted into the lower portion of the stopper 210, the flap 220 may be inclined toward the first divided flow path 141, thus blocking the entire first divided flow path 141 or a part thereof. According to an embodiment of the disclosure, the locking portion 230 and the support portion 240 of the flap 220 may protrude toward the second divided flow path 142 from the side wall 222.

Referring to FIG. 13, in the low rpm section, the second divided flow path 142 connected to the second suction reed 182 having a low rigidity and a low natural frequency may be opened and the first divided flow path 141 may be blocked or partially opened.

The low rpm section according to an embodiment of the disclosure may refer to a state where the pressure of the fluid introduced to the exit flow path 140 is less than the weight of the stopper 210 and a section where the stopper 210 is not moved by the pressure of the fluid.

When the stopper 210 is not moved by the pressure of the fluid, the entire first divided flow path 141 or a part thereof may be blocked by the side wall 222 of the flap 220. As the support portion 240 provided on the lower portion of the side wall 222 of the flap 220 includes the second opening 241 and the locking portion 230 provided on the upper portion of the side wall 222 includes the first opening 231, the fluid may move to the second divided flow path 142 through the flap 220. The fluid moving to the second divided flow path 142 may be suctioned to the compression module 10 by passing through the second suction hole 164 and the second suction reed 182.

Referring to FIG. 14, in the high rpm section, the first divided flow path 141 connected to the first suction reed 181 having a high rigidity and a high natural frequency may be opened and the second divided flow path 142 may be blocked.

The high rpm section according to an embodiment of the disclosure may refer to a state where the pressure of the fluid introduced to the exit flow path 140 is greater than the weight of the stopper 210 and a section where the stopper 210 is moved by the pressure of the fluid.

When the stopper 210 is moved by the pressure of the fluid, the stopper 210 may move toward the locking portion 230 along the guide portion 250. The first opening 231 provided in the locking portion 230 may be a hole with a size less than that of the stopper 210, and when the stopper 210 moves to the locking portion 230, the stopper 210 may contact the first frame 232 while blocking the first opening 231 of the locking portion 230.

Referring to FIG. 13, before the stopper 210 is moved by the pressure of the fluid, a side of the support portion 240 may be inserted into the stopper 210 such that the flap 220 may be inclined toward the first divided flow path 141. However, when the stopper 210 is moved by the pressure of the fluid, the stopper 210 may leave the support portion 240, rotating the flap 220, such that the first divided flow path 141 may be opened.

In this case, as the stopper 210 closes the first opening 231 of the locking portion 230, the second divided flow path 142 may be closed. Thus, the fluid introduced to the exit flow path 140 may be discharged through the first divided flow path 141, and the fluid moved to the first divided flow path 141 may be suctioned to the compression module 10 through the first suction hole 163 and the first suction reed 181.

As such, with the variable flow path portion 200 according to an embodiment of the disclosure, the fluid may move through the divided flow path connected to the suction reed (the second suction reed 182) having a low rigidity and a low natural frequency in the low rpm section, and the fluid may move through the divided flow path connected to the suction reed (the first suction reed 181) having a high rigidity and a high natural frequency in the high rpm section.

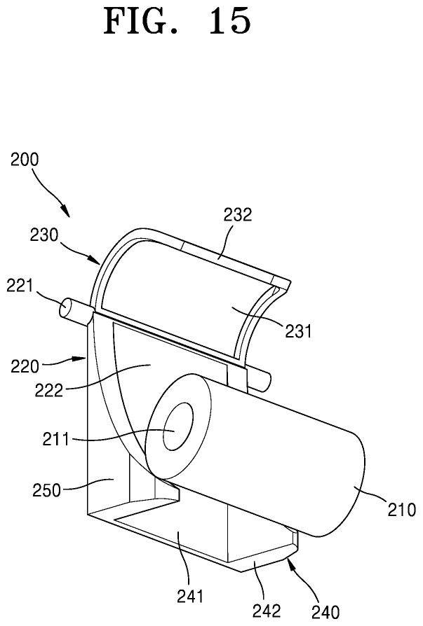

FIG. 15 schematically shows a hollow 211 formed in the stopper 210, according to an embodiment of the disclosure. Referring to FIG. 15, in the stopper 210 according to an embodiment of the disclosure, the hollow 211 may be formed.

The stopper 210 needs to have such a weight not to be moved by the pressure of the fluid in the low rpm section, and needs to have such a weight to be moved by the pressure of the fluid in the high rpm section. The weight of the stopper 210 according to an embodiment of the disclosure may be adjusted by the hollow 211 formed in the stopper 210.

More specifically, the weight of the stopper 210 may be adjusted by adjusting the size of the hollow 211 formed in the stopper 210, and in this way, the stopper 210 may not be moved by the pressure of the fluid in the low rpm section and may be moved by the pressure of the fluid in the high rpm section. According to an embodiment of the disclosure, an rpm section in which the stopper 210 is to be moved may change with the rigidity, the natural frequency, and the shape of the suction reed 180.

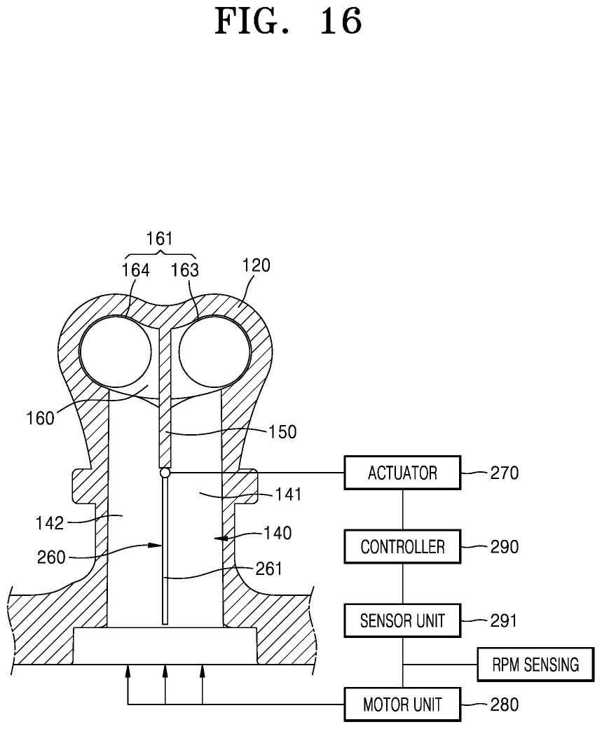

The variable flow path portion 200 according to an embodiment of the disclosure may include an opening and closing unit 260 and an actuator 270. FIG. 16 schematically shows the variable flow path portion 200 including the opening and closing unit 260 and the actuator 270, according to an embodiment of the disclosure.

Referring to FIG. 16, the opening and closing unit 260 according to an embodiment of the disclosure may move inside the exit flow path 140. According to an embodiment of the disclosure, the opening and closing unit 260 may be a rotatable barrier 261 rotatably coupled to the barrier 150. The rotatable barrier 261 may move inside the exit flow path 140 while being rotatably coupled to the barrier 150, and open or close any one of the plurality of divided flow paths as the rotatable barrier 261 moves.

The actuator 270 according to an embodiment of the disclosure may move the opening and closing unit 260. The actuator 270 supplies power for moving the opening and closing unit 260 by being connected to the opening and closing unit 260, and the actuator 270 may be a motor.

The muffler for a compressor according to an embodiment of the disclosure may further include a motor unit 280, a sensor unit 291, and a controller 290. The motor unit 280 according an embodiment of the disclosure may supply power for introducing the fluid to the body portion 110. The motor unit 280 may include a motor, and a pressure of the fluid supplied to the body portion 110 may change with the rpm of the motor unit 280.

The sensor unit 291 according to an embodiment of the disclosure may measure the rpm of the motor unit 280. The sensor unit 291 may include a sensor capable of measuring the rpm of the motor unit 280. The controller 290 according to an embodiment of the disclosure may control an operation of the actuator 270. The controller 290 according to an embodiment of the disclosure may control the operation of the actuator 270 based on the rpm of the motor unit 280 measured by the sensor unit 291.

According to an embodiment of the disclosure, the controller 290 may control the operation of the actuator 270 to open the second divided flow path 142 connected to the second suction reed 182 having a low rigidity and a low natural frequency and to close the first divided flow path 141 connected to the first suction reed 181 having a high rigidity and a high natural frequency, in the low rpm section.

The controller 290 may also control the operation of the actuator 270 to open the first divided flow path 141 connected to the first suction reed 181 having a high rigidity and a high natural frequency and to close the second divided flow path 142 connected to the second suction reed 182 having a low rigidity and a low natural frequency, in the high rpm section.

By controlling the operation of the variable flow path portion 200 including the opening and closing unit 260 and the actuator 270 through the controller 290, the fluid may be moved through the divided flow path connected to the suction reed (the second suction reed 182) having a low rigidity and a low natural frequency in the low rpm section and may be moved through the divided flow path connected to the suction reed (the first suction reed 181) having a high rigidity and a high natural frequency in the high rpm section.

The muffler for a compressor according to an embodiment of the disclosure may have effects described below. Referring to FIG. 8, for the plurality of suction reeds 180 having the same rigidity, the same natural frequency, and the same shape in the suction valve 170, when the exit hole of the outlet 130 includes one hole without being divided by the barrier, a difference in an opening amount may occur among the plurality of suction reeds 180.

More specifically, as the fluid discharged through one exit hole is not uniformly moved to the plurality of suction reeds 180, a difference in an opening amount may occur among the plurality of suction reeds 180.

However, in the muffler for a compressor according to an embodiment of the disclosure, the exit hole of the outlet 130 may be divided through the barrier 150 and each of the plurality of suction holes communicate with the divided exit hole, thereby dividing a passage of the fluid moving to the plurality of suction reeds 180.

To this end, when the plurality of suction reeds 180 of the suction valve 170 have the same rigidity, the same natural frequency, and the same shape, a difference in an opening amount occurring among the plurality of suction reeds 180 may be reduced.

Referring to FIG. 11, for any one or more of the plurality of suction reeds 180 having different rigidities, different natural frequencies, and different shapes in the suction valve 170, when the exit hole of the outlet 130 includes one hole without being divided by the barrier, a long opening delay or a large opening amount difference may occur among the plurality of suction reeds 180. In addition, the suction reed 180 may be opened even after a bottom dead center that is a time point at which the fluid is discharged after suctioned in the compression module 10.

However, in the muffler for a compressor according to an embodiment of the disclosure, the exit hole of the outlet 130 may be divided through the barrier 150 and each of the plurality of suction holes communicate with the divided exit hole, thereby dividing a passage of the fluid moving to the plurality of suction reeds 180.

In this way, for any one or more of the plurality of suction reeds 180 having different rigidities, different natural frequencies, and different shapes, an opening amount difference among the plurality of suction reeds 180 may be reduced and an opening delay and opening of the suction reed 180 after the bottom dead center may be prevented.

Referring to FIG. 12, when the fluid is moved through suction reeds having different rigidities and different natural frequencies, an opening amount of the suction reed having a high rigidity and a high natural frequency may be less than that of the suction reed having a high rigidity and a high natural frequency in the low rpm section. Moreover, in the high rpm section, an opening and closing delay may occur in the suction reed having a low rigidity and a low natural frequency, such that the suction reed may be opened after the bottom dead center.

Thus, it is necessary to form differently the exit flow path and the suction reed through which the fluid passes in the low rpm section and the exit flow path and the suction reed through which the fluid passes in the high rpm section.

The muffler for a compressor according to an embodiment of the disclosure may include the barrier 150 and the variable flow path portion 200 that selectively opens or closes any one or more of the exit flow paths 140 divided by the barrier 150.

The muffler for a compressor according to an embodiment of the disclosure may separate the exit flow path 140 and the suction reed 180 through which the fluid moves in the low rpm section from the exit flow path 140 and the suction reed 180 through which the fluid moves in the high rpm section, through the variable flow path portion 200.

Thus, in the muffler for a compressor according to an embodiment of the disclosure, when the fluid is moved through the suction reeds having different rigidities and different natural frequencies, it is possible to prevent an opening amount difference between the suction reeds from occurring and the suction reeds from being opened after the bottom dead center.

Effects obtainable in the disclosure are not limited to the effects mentioned above, and other effects not mentioned above may be clearly understood by those of ordinary skill in the art from the foregoing description.

To understand the disclosure, reference numerals have been given in embodiments of the disclosure shown in the drawings, and specific terms are used to describe the embodiments of the disclosure, but the disclosure is not limited by the specific terms, and the disclosure may include all the components that are normally thought by those of ordinary skill in the art.

Certain executions described here are embodiments of the disclosure, not limiting the scope of the disclosure in any way. For the brevity of the specification, the description of conventional electronic configurations, control systems, software, and other functional aspects of the systems may be omitted. Connections of lines or connection members between components shown in the drawings are illustrative of functional connections and/or physical or circuit connections, and in practice, may be represented as alternative or additional various functional connections, physical connections, or circuit connections. In addition, when there is no specific mentioning, such as “essential” or “important”, it may not be a necessary component for the application of the disclosure. An expression such as “comprising”, “including”, etc., used herein has been used to be understood as terms of an open end of the description.

In the specification (especially, claims) of the disclosure, the use of the term “the” and similar indicators thereof may correspond to both the singular and the plural. In addition, when the range is described in the disclosure, the range includes the disclosure to which an individual value falling within the range is applied (unless stated otherwise), and is the same as the description of an individual value constituting the range in the detailed description of the disclosure. Finally, when there is no apparent description of the order of operations constituting the method according to the disclosure or a contrary description thereof, the operations may be performed in an appropriate order. However, the disclosure is not necessarily limited according to the describing order of the operations.

The use of all examples or exemplary terms (for example, etc.) in the disclosure are to simply describe the disclosure in detail, and unless the range of the disclosure is not limited by the examples or the exemplary terms unless limited by the claims. In addition, it would be apparent to those of ordinary skill in the art that various modifications and changes may be easily made without departing from the scope and spirit of the disclosure.

A muffler for a compressor according to an embodiment of the disclosure may prevent an opening amount difference or an opening delay from occurring in a compressor using a suction valve provided with a plurality of suction reeds.

When the muffler for the compressor according to an embodiment of the disclosure uses the plurality of suction reeds having the same rigidity, the same natural frequency, or the same shape or the plurality of suction reeds having different rigidities, different natural frequencies, and different shapes, it is possible to reduce an opening amount difference occurring among the plurality of suction reeds and prevent an opening delay and opening of the suction reed after the bottom dead center.

The muffler for the compressor according to an embodiment of the disclosure may separate the exit flow path and the suction reed through which the fluid moves in the low rpm section from the exit flow path and the suction reed through which the fluid moves in the high rpm section, through the variable flow path portion that selectively opens or closes any one or more of the exit flow paths divided by the barrier.

A muffler for a compressor according to an embodiment of the disclosure may be a muffler mounted on a compressor.

The muffler may include a body portion including an inlet to which a fluid is introducible and a base portion connected to the body portion, the base portion.

The base portion of the muffler for the compressor according to an embodiment of the disclosure may include an exit flow path, an outlet at an end of the exit flow path, and a barrier extending from the outlet through the exit flow path so as to divide an exit hole of the outlet and the exit flow path.

The fluid of the muffler for the compressor according to an embodiment of the disclosure may be introduced to the body portion flows through the base portion via the exit flow path and is discharged through the exit hole of the outlet.

The exit flow path of the muffler for the compressor according to an embodiment of the disclosure may be divided into a plurality of divided flow paths by the barrier, and the plurality of divided flow paths have a same cross-sectional area.

The exit flow path of the muffler for the compressor according to an embodiment of the disclosure may be divided into a plurality of divided flow paths by the barrier, and the plurality of divided flow paths have different cross-sectional areas.

The barrier extending from the outlet to the exit flow path may extend by a length of about 0.1 to about 1 time a length of the exit flow path 140.

The muffler for the compressor according to an embodiment of the disclosure may further include a valve assembly including a plurality of suction holes configured to communicate with the exit hole of the outlet, The number of suction holes of the plurality of suction holes in the valve assembly is equal to a number of exit holes divided by the barrier.

The muffler for the compressor according to an embodiment of the disclosure may further include a suction valve configured to open and close the plurality of suction holes of the valve assembly according to movement of the fluid. The valve assembly is formed in a plate shape. The suction valve including a valve plate is formed in a plate shape, and a plurality of suction reeds each cut from the valve plate so as to be coupled at one end to the valve plate.

At least two suction reeds among the plurality of suction reeds have different rigidities, different natural frequencies, or different shapes. The muffler may include a body portion including an inlet to which a fluid is introducible and a base portion connected to the body portion.

The base portion of the muffler for the compressor according to an embodiment of the disclosure may include an exit flow path, an outlet at an end of the exit flow path, a barrier extending from the outlet through the exit flow path so as to divide an exit hole of the outlet into a plurality of exit holes, and to divide the exit flow path into a plurality of divided flow paths, and a variable flow path portion in the exit flow path.

The fluid of the muffler for the compressor according to an embodiment of the disclosure may be introduced to the body portion flows through the base portion via the exit flow path and is discharged through the exit hole of the outlet, and the variable flow path portion is configured to open and close at least one divided flow path of the plurality of divided flow paths.

The variable flow path portion of the muffler for the compressor according to an embodiment of the disclosure may include a flap, and a stopper formed in a cylindrical shape and disposed in the exit flow path.

The flap of the muffler for the compressor according to an embodiment of the disclosure may include a hinge portion coupled to the barrier so that the flap is rotatable, a side wall coupled to the hinge portion, a locking portion on an upper portion of the side wall, and including a first frame having a first opening through which the fluid is passable, and a support portion on a lower portion of the side wall, and including a second frame having a second opening through which the fluid is passable. The side of the support portion of the flap is inserted into a portion of the stopper. The flap of the muffler for the compressor according to an embodiment of the disclosure may further include a guide portion extending upward from the support portion and forming a curve toward the locking portion.

A hollow may be formed in the stopper of the muffler for the compressor according to an embodiment.

The variable flow path portion of the muffler for the compressor according to an embodiment of the disclosure may include an opening and closing unit moving inside the exit flow path and an actuator moving the opening and closing unit.

The muffler for the compressor according to an embodiment of the disclosure may further include a motor unit configured to supply power to introduce the fluid to the body portion, a sensor unit configured to measure revolutions per minute (rpm) of the motor unit, and a controller configured to control an operation of the actuator based on the rpm measured by the sensor unit.

The muffler for the compressor according to an embodiment of the disclosure may further include a valve assembly including a plurality of suction holes communicating with the exit hole of the outlet.

The number of suction holes provided in the valve assembly of the muffler for the compressor according to an embodiment of the disclosure may be equal to the number of exit holes divided by the barrier.

The muffler for the compressor according to an embodiment of the disclosure may further include a suction valve opening and closing the suction hole of the valve assembly according to movement of the fluid. The valve assembly is formed in a plate shape. The suction valve including a valve plate is formed in a plate shape, and a plurality of suction reeds each cut from the valve plate so as to be coupled at one end to the valve plate.

At least two of the plurality of suction reeds of the muffler for the compressor according to an embodiment of the disclosure may have different rigidities, different natural frequencies, or different shapes.

1. A muffler that is mountable on a compressor, the muffler comprising:
a body portion including an inlet to which a fluid is introducible; and
a base portion connected to the body portion,
the base portion including:
an exit flow path,
an outlet at an end of the exit flow path, and
a barrier extending from the outlet through the exit flow path so as to divide an exit hole of the outlet and the exit flow path,
wherein the fluid introduced to the body portion flows through the base portion via the exit flow path and is discharged through the exit hole of the outlet.

2. The muffler of claim 1, wherein
the exit flow path is divided into a plurality of divided flow paths by the barrier, and
the plurality of divided flow paths have a same cross-sectional area.

3. The muffler of claim 1, wherein
the exit flow path is divided into a plurality of divided flow paths by the barrier, and the plurality of divided flow paths have different cross-sectional areas.

4. The muffler of claim 1, wherein
the barrier extends from the outlet through the exit flow path by a length of about 0.1 to about 1 time a length of the exit flow path.

5. The muffler of claim 1, further comprising:
a valve assembly including a plurality of suction holes configured to communicate with the exit hole of the outlet,
wherein a number of suction holes of the plurality of suction holes in the valve assembly is equal to a number of exit holes divided by the barrier.

6. The muffler of claim 5, further comprising:
a suction valve configured to open and close the plurality of suction holes of the valve assembly according to movement of the fluid,
wherein the valve assembly is formed in a plate shape,
wherein the suction valve including a valve plate is formed in a plate shape, and a plurality of suction reeds each cut from the valve plate so as to be coupled at one end to the valve plate.

7. The muffler of claim 6, wherein
at least two suction reeds among the plurality of suction reeds have different rigidities, different natural frequencies, or different shapes.

8. A muffler that is mountable on a compressor, the muffler comprising:
a body portion including an inlet to which a fluid is introducible; and
a base portion connected to the body portion,
the base portion including:
an exit flow path,
an outlet at an end of the exit flow path,
a barrier extending from the outlet through the exit flow path so as to divide an exit hole of the outlet into a plurality of exit holes, and to divide the exit flow path into a plurality of divided flow paths, and
a variable flow path portion in the exit flow path,
wherein the fluid introduced to the body portion flows through the base portion via the exit flow path and is discharged through the exit hole of the outlet, and
the variable flow path portion is configured to open and close at least one divided flow path of the plurality of divided flow paths.

9. The muffler of claim 8, wherein
the variable flow path portion includes:
a flap, and a stopper formed in a cylindrical shape and disposed in the exit flow path
wherein the flap including:
a hinge portion coupled to the barrier so that the flap is rotatable,
a side wall coupled to the hinge portion,
a locking portion on an upper portion of the side wall, and including:
a first frame having a first opening through which the fluid is passable, and
a support portion on a lower portion of the side wall, and including:
a second frame having a second opening through which the fluid is passable, and
wherein a side of the support portion of the flap is inserted into a portion of the stopper.

10. The muffler of claim 9, wherein
the flap includes:
a guide portion extending upward from the support portion and forming a curve toward the locking portion.

11. The muffler of claim 9, wherein
a hollow is formed in the stopper.

12. The muffler of claim 8, wherein
the variable flow path portion includes:
an opening and closing unit configured to move inside the exit flow path, and
an actuator configured to move the opening and closing unit.

13. The muffler of claim 12, further comprising:
a motor unit configured to supply power to introduce the fluid to the body portion;
a sensor unit configured to measure revolutions per minute (rpm) of the motor unit; and
a controller configured to control an operation of the actuator based on the rpm measured by the sensor unit.

14. The muffler of claim 9, further comprising:
a valve assembly including a plurality of suction holes configured to communicate with the exit hole of the outlet,
wherein a number of suction holes of the plurality of suction holes in the valve assembly is equal to a number of exit holes divided by the barrier.

15. The muffler of claim 14, further comprising
a suction valve configured to open and close the plurality of suction holes of the valve assembly according to movement of the fluid,
wherein the valve assembly is formed in a plate shape,
wherein the suction valve including a valve plate is formed in a plate shape, and a plurality of suction reeds each cut from the valve plate so as to be coupled at one end to the valve plate,
wherein at least two suction reeds among the plurality of suction reeds have different rigidities, different natural frequencies, or different shapes.
